(19) United States
(12) Patent Application Publication
(10) Pub. No.: US 2014/0092016 A1
(43) Pub. Date: Apr. 3, 2014

(54) Handheld Pointing Device and Operation Method Thereof

(71) Applicant: PIXART IMAGING INC., Hsinchu City (TW)

(72) Inventors: Ming-Tsan KAO, HSINCHU City (TW); Chia-Cheun LIANG, HSINCHU City (TW)

(73) Assignee: PixArt Imaging Inc., Hsinchu City (TW)

(21) Appl. No.: 13/865,188

(22) Filed: Apr. 17, 2013

(30) Foreign Application Priority Data
Sep. 28, 2012 (TW) 101136016

(51) Int. Cl. G06F 3/038

(52) U.S. Cl. CPC G06F 3/038
USPC 345/158

(57) ABSTRACT

A handheld pointing device includes a body, an image sensing module and a processing circuit. The image sensing module is disposed in the body and configured to sense a reference light source and thereby capturing an image including of the reference light source. The processing circuit, disposed in the body and electrically connected to the image sensing module, is configured to obtain the image including of the reference light source, calculate a coordinate of the image of the reference light source relative to the image captured by the image sensing module, and correct the coordinate according to a distance or a distance change between the body and the reference light source. An operation method of a handheld pointing device is also provided.

### FIELD OF THE INVENTION

The present invention relates to the optical touch technology field, and more particularly to a handheld pointing device and an operation method thereof.

### BACKGROUND OF THE INVENTION

Basically, handheld pointing device is for use with a host apparatus, a display apparatus and a reference light source. In the current technology, the handheld pointing device is configured to first sense, by using an image sensing module arranged therein, the reference light source located near the a display screen of the display apparatus; capture an image including the reference light source; calculate the coordinate position of the image of the reference light source in the captured image; and output the calculated coordinate position to the host apparatus. Thus, the host apparatus can control a particular object (e.g., a cursor) on an image shown on the display screen of the display apparatus according to the coordinate position.

However, when the handheld pointing device is moving in a fixed direction and gradually toward or away from the display apparatus, the reference light source in the image captured by the image sensing module may have a down or up offset, respectively. Consequently, errors may happen if the host apparatus controls a particular object on an image shown on the display screen of the display apparatus according to the coordinate position with offset.

### SUMMARY OF THE INVENTION

The present invention provides a handheld pointing device capable of preventing the host apparatus from having the aforementioned errors.

The present invention also provides an operation method of the aforementioned handheld pointing device.

An embodiment of the present invention provides a handheld pointing device, which includes a body, an image sensing module and a processing circuit. The image sensing module is disposed in the body and configured to sense a reference light source and thereby capturing an image including of the reference light source. The processing circuit, disposed in the body and electrically connected to the image sensing module, is configured to obtain the image including of the reference light source, calculate a coordinate of the image of the reference light source relative to the image captured by the image sensing module, and correct the coordinate according to a distance or a distance change between the body and the reference light source.

Another embodiment of the present invention provides an operation method of a handheld pointing device. The handheld pointing device includes a body and an image sensing module. The image sensing module is disposed in the body and configured to sense a reference light source and thereby capturing an image including of the reference light source. The operation method includes: calculating a coordinate of the image of the reference light source relative to the image captured by the image sensing module; and correcting the coordinate according to a distance or a distance change between the body and the reference light source.

In summary, by first configuring an image sensing module to sense a reference light source and thereby capturing an image including of the reference light source and then configuring a processing circuit to calculate the coordinate of the image of the reference light source relative to the image captured by the image sensing module, the handheld pointing device according to the present invention, while being pointing in a fixed direction and gradually moving toward or away from a display apparatus, can correct the previously-calculated coordinate of the reference light source based on the distance or the distance change between the body thereof and the reference light source. Consequently, according to the corrected coordinates, the host apparatus for use with the handheld pointing device can control an object (e.g., a cursor) shown on the display screen of the display apparatus thereof more accurately and thereby preventing errors from occurring.

### BRIEF DESCRIPTION OF THE DRAWINGS

The present invention will become more readily apparent to those ordinarily skilled in the art after reviewing the following detailed description and accompanying drawings, in which:

FIG. 1 is a schematic perspective view of a handheld pointing device in accordance with an embodiment of the present invention;

FIG. 2 is a schematic perspective view of a handheld pointing device in accordance with another embodiment of the present invention;

FIG. 3 is a schematic perspective view of a handheld pointing device in accordance with still another embodiment of the present invention;

FIG. 4 is a schematic perspective view of a handheld pointing device in accordance with yet another embodiment of the present invention; and

FIG. 5 is a schematic flowchart illustrating an operation method of a handheld pointing device in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

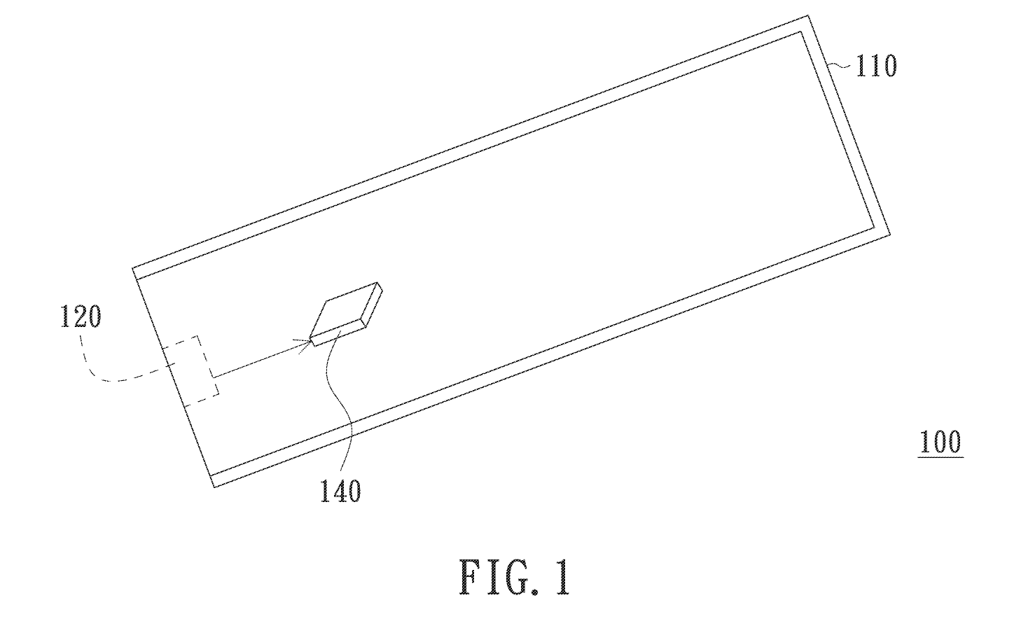

FIG. 1 is a schematic perspective view of a handheld pointing device in accordance with an embodiment of the present invention. As shown, the handheld pointing device 100 in this embodiment includes a body 110, an image sensing module 120 and a processing circuit 140; wherein the image sensing module 120 and processing circuit 140 both are arranged in the body 110, and the present invention is not limited thereto. The image sensing module 120 is configured to sense a reference light source (not shown) and thereby capturing an image including of the reference light source. The processing circuit 140, electrically connected to the image sensing module 120, is configured to obtain the image including of the reference light source, calculate the coordinate of the image of the reference light source relative to the image captured by the image sensing module 120, and correct the previously-calculated coordinate according to a distance or a distance change between the body 110 and the reference light source.

In this embodiment, the processing circuit 140 first determines the distance between the body 110 and the reference light source based on an image size of the reference light source. In addition, the processing circuit 140 further determines the reference light source whether or not having an image size matching with one of a number of different predetermined sizes. Specifically, if the reference light source has an image size matched with one of the predetermined sizes or the image size is within an allowable error from the predetermined size, the processing circuit 140 can determine the distance between the body 110 and the reference light source according to the predetermined size. It is to be noted that the aforementioned distance or distance change are not always required to be calculated directly; in some embodiments, the distance or the distance change can be expressed by a formula of the imaging distance of two reference light sources, an imaging size of one single reference light source, or an area change of a reference light source. Furthermore, the handheld pointing device 100 may store with a lookup table (not shown), which records a relationship between imaging characteristic of at least one reference light source and a group of coordinate adjustment parameters; thus, the processing circuit 140 can correct the coordinate based on the relationship between the imaging characteristic of the reference light source(s) and the group of coordinate adjustment parameters recorded in the lookup table.

Accordingly, when being pointing in a fixed direction and gradually moving toward or away from a display apparatus (not shown), the handheld pointing device 100 in this embodiment can correct the previously-calculated coordinate of the reference light source based on the distance or the distance change between the body 110 and the reference light source. Consequently, according to the corrected coordinates, the host apparatus for use with the handheld pointing device 100 can control an object (e.g., a cursor) shown on the display screen of the display apparatus thereof more accurately and thereby preventing errors from occurring.

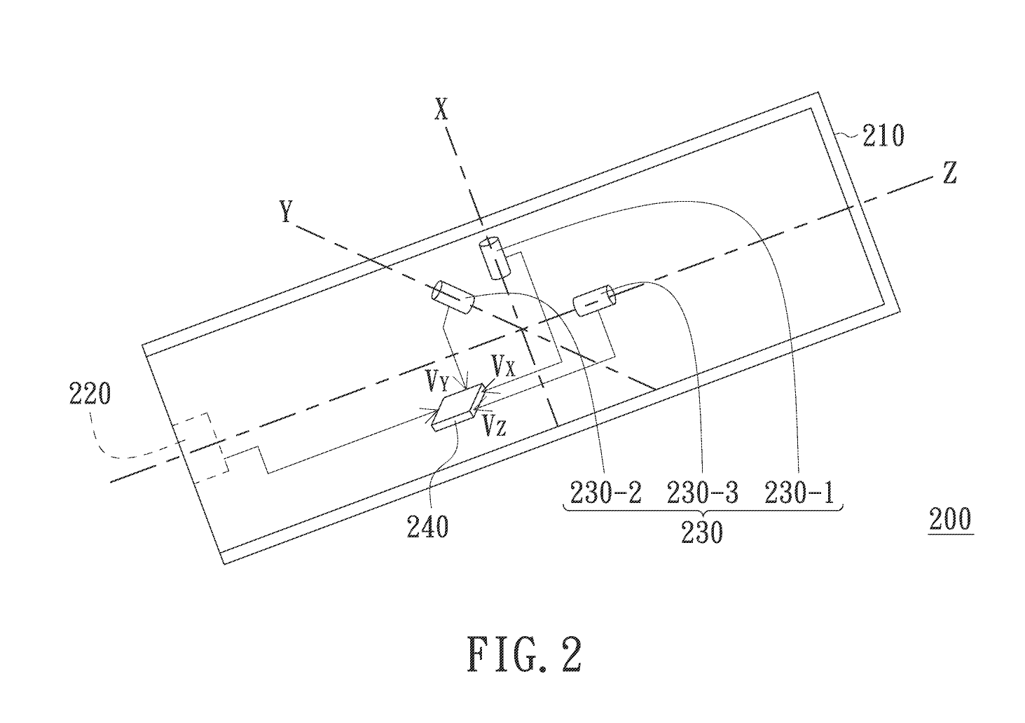

FIG. 2 is a schematic perspective view of a handheld pointing device in accordance with another embodiment of the present invention. As shown, the handheld pointing device 200 in this embodiment includes a body 210, an image sensing module 220, an acceleration sensing module 230 and a processing circuit 240; wherein the image sensing module 220, the acceleration sensing module 230 and the processing circuit 240 all are arranged in the body 210, and the present invention is not limited thereto.

The image sensing module 220 is configured to sense a reference light source (not shown) and thereby capturing an image including of the reference light source. The acceleration sensing module 230 is configured to obtain the three acceleration values V_{X}, V_{Y} and V_{Z} of the body 210 respectively on the X-axis, Y-axis and Z-axis in a three-dimensional space. In this embodiment, the acceleration sensing module 230 includes three acceleration sensors 230-1, 230-2 and 230-3, which are configured to sense the acceleration values V_{X}, V_{Y} and V_{Z} and then output the sensed acceleration values V_{X}, V_{Y} and V_{Z} to the processing circuit 240, respectively. Specifically, if the acceleration value V_{Z} is the acceleration of the body 210 moving toward or away from the reference light source, the processing circuit 240 first calculates the displacement of the body 210 relative to the reference light source according to the acceleration value V_{Z}, and then further calculates the distance between the body 210 and the reference light source according to the displacement.

Accordingly, when being pointing in a fixed direction and gradually moving toward or away from a display apparatus (not shown), the handheld pointing device 200 can correct the previously-calculated coordinate of the reference light source based on the distance or the distance change between the body 210 and the reference light source. In addition, to those ordinarily skilled in the art, it is understood that the handheld pointing device 200 may employ one acceleration sensor only if this employed acceleration sensor is capable of obtaining the acceleration value of the body 210 moving toward or away from the reference light source. For example, the handheld pointing device 200 may employ the acceleration sensor 230-3 only; and accordingly, the processing circuit 240 first calculates the displacement of the body 210 relative to the reference light source according to the acceleration value V_{Z}, and then further calculates the distance between the body 210 and the reference light source according to the displacement.

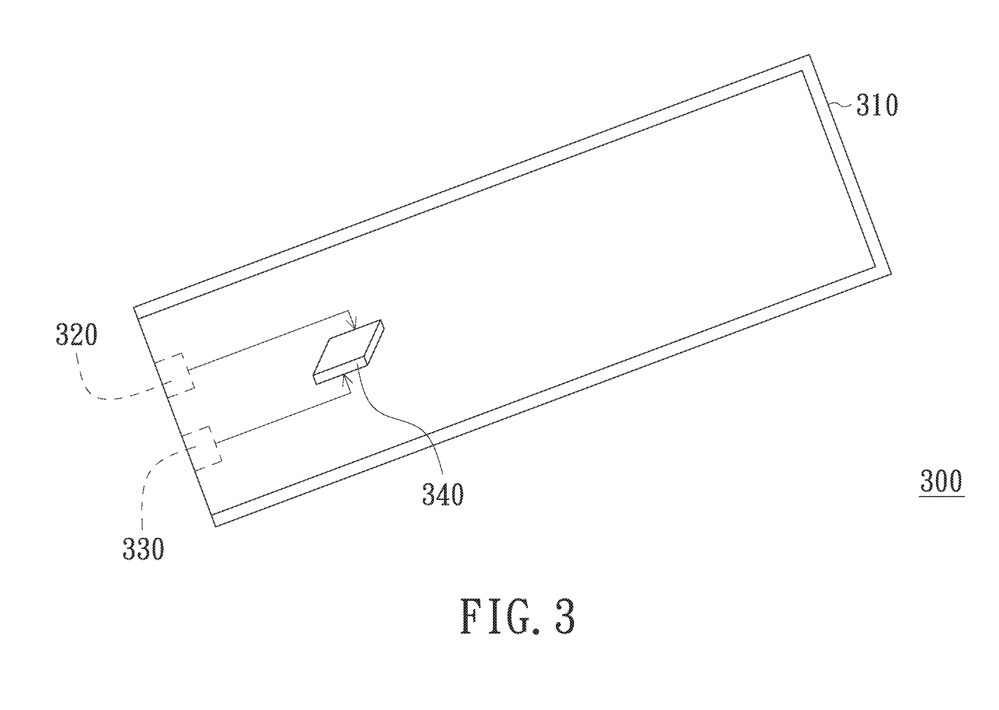

FIG. 3 is a schematic perspective view of a handheld pointing device in accordance with still another embodiment of the present invention. As shown, the handheld pointing device 300 in this embodiment includes a body 310, an image sensing module 320, a distance measuring device 330 and a processing circuit 340; wherein the image sensing module 320, the distance measuring device 330 and the processing circuit 340 all are arranged in the body 310, and the present invention is not limited thereto. The image sensing module 320 is configured to sense a reference light source (not shown) and thereby capturing an image including of the reference light source. The distance measuring device 330 is configured to measure the distance between the body 310 and the reference light source and then output a sensing result (e.g., the measured distance) to the processing circuit 340. In this embodiment, the distance measuring device 330 is, for example, realized by a laser distance measuring device.

Accordingly, when being pointing in a fixed direction and gradually moving toward or away from a display apparatus (not shown), the handheld pointing device 300 can correct the previously-calculated coordinate of the reference light source based on the distance or the distance change between the body 310 and the reference light source.

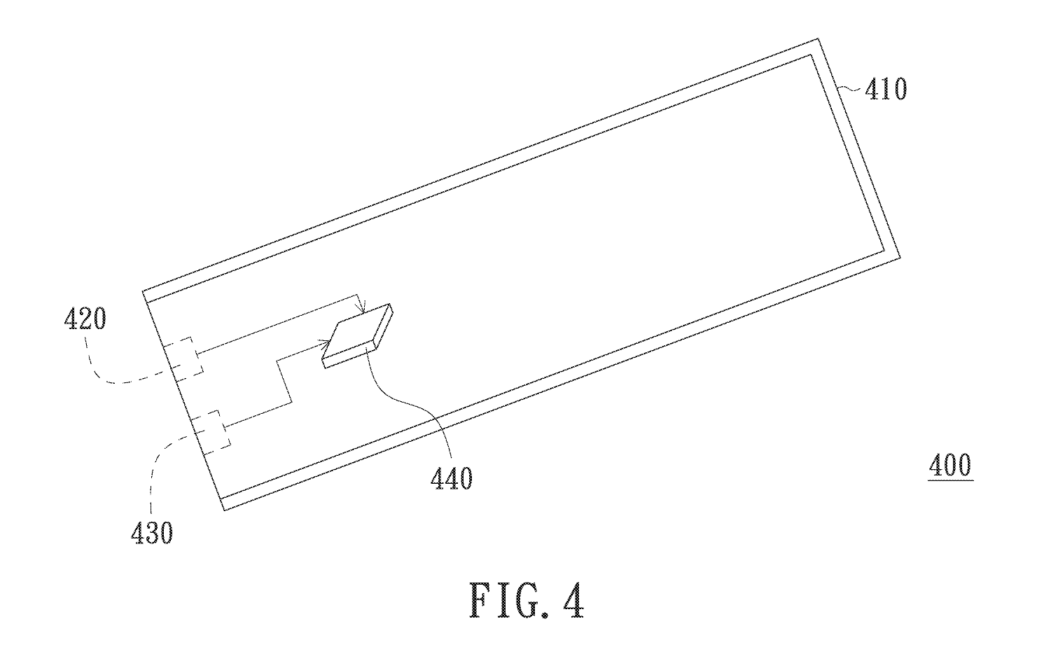

FIG. 4 is a schematic perspective view of a handheld pointing device in accordance with yet another embodiment of the present invention. As shown, the handheld pointing device 400 in this embodiment includes a body 410, an image sensing module 420, a light-emitting device 430 and a processing circuit 440; wherein the image sensing module 420, the light-emitting device 430 and the processing circuit 440 all are arranged in the body 410, and the present invention is not limited thereto. The image sensing module 420 is configured to sense a reference light source (not shown) and thereby capturing an image including of the reference light source. The light-emitting device 430 is configured to emit striped lights on the reference light source or on the plane where the reference light source is. Thus, the image captured by the image sensing module 420 can include of the image of the striped lights emitting on the reference light source or on the plane where the reference light source is; and the processing circuit 440 can determine the distance between the body 410 and the reference light source according to the distance between two consecutive stripes in the image captured by the image sensing module 420.

Accordingly, when being pointing in a fixed direction and gradually moving toward or away from a display apparatus (not shown), the handheld pointing device 400 can correct the previously-calculated coordinate of the reference light source based on the distance or the distance change between the body 410 and the reference light source.

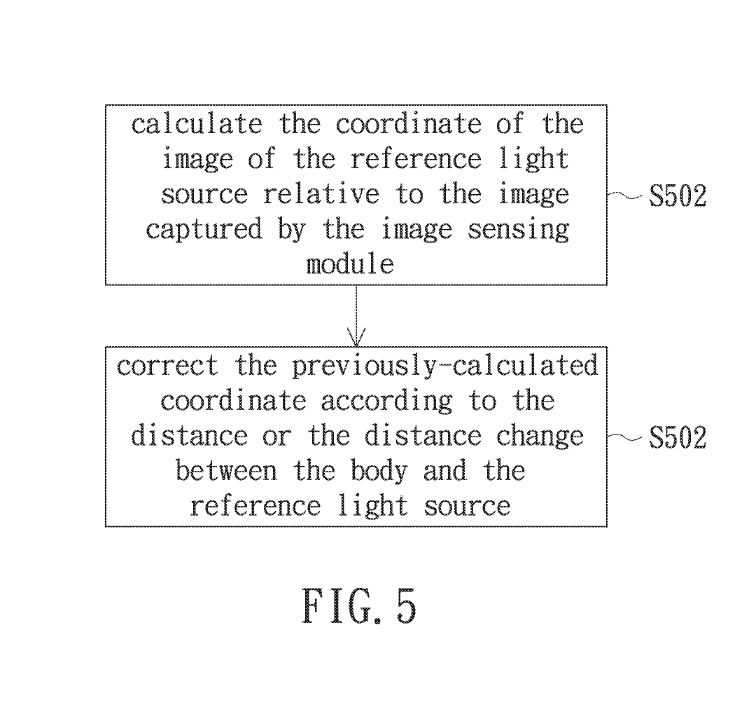

According to the aforementioned embodiments, an operation method of a handheld pointing device can be summarized to have some basic operation steps by those ordinarily skilled in the art. FIG. 5 is a schematic flowchart illustrating an operation method of a handheld pointing device in accordance with an embodiment of the present invention. Specifically, the handheld pointing device includes a body and an image sensing module; the image sensing module is arranged in the body and configured to sense a reference light source and thereby capturing an image including of the reference light source. As shown in FIG. 5, the operation method includes steps of: calculating the coordinate of the image of the reference light source relative to the image captured by the image sensing module (step S502); and correcting the previously-calculated coordinate according to the distance or the distance change between the body and the reference light source (step S504).

In summary, by first configuring an image sensing module to sense a reference light source and thereby capturing an image including of the reference light source and then configuring a processing circuit to calculate the coordinate of the image of the reference light source relative to the image captured by the image sensing module, the handheld pointing device according to the present invention, while being pointing in a fixed direction and gradually moving toward or away from a display apparatus, can correct the previously-calculated coordinate of the reference light source based on the distance or the distance change between the body thereof and the reference light source. Consequently, according to the corrected coordinates, the host apparatus for use with the handheld pointing device can control an object (e.g., a cursor) shown on the display screen of the display apparatus thereof more accurately and thereby preventing errors from occurring.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A handheld pointing device, comprising:
a body;
an image sensing module disposed in the body and configured to sense a reference light source and thereby capturing an image including of the reference light source; and
a processing circuit, disposed in the body and electrically connected to the image sensing module, configured to obtain the image including of the reference light source, calculate a coordinate of the image of the reference light source relative to the image captured by the image sensing module, and correct the coordinate according to a distance or a distance change between the body and the reference light source.

2. The handheld pointing device according to claim 1, wherein the processing circuit determines the distance based on an image size of the reference light source.

3. The handheld pointing device according to claim 2, wherein the processing circuit is further configured to determine the reference light source whether or not having an image size matching with one of a plurality of different predetermined sizes; and the processing circuit, if the reference light source has an image size matched with one of the predetermined sizes or the image size is within an allowable error form the predetermined size, determines the distance according to this one predetermined size.

4. The handheld pointing device according to claim 1, wherein the image sensing module is further configured to sense two reference light sources and thereby capturing an image including of the two reference light sources, wherein the distance change is associated with an imagining distance change of the two reference light sources in the captured image.

5. The handheld pointing device according to claim 1, wherein the processing circuit corrects the coordinate according to an area size change of the image of the reference light source, wherein the distance change is associated with the area size change of the image of the reference light sources.

6. The handheld pointing device according to claim 1, further comprising an acceleration sensing device configured to obtain an acceleration value of the body moving toward or away from the reference light source, and the processing circuit corrects the coordinate according to the acceleration value.

7. The handheld pointing device according to claim 6, wherein the processing circuit calculates a displacement of the body relative to the reference light source according to the acceleration value, and thereby calculating the distance change according to the displacement.

8. The handheld pointing device according to claim 1, further comprising an acceleration sensing module configured to obtain three acceleration values of the body respectively in three dimensions of a space, wherein the processing circuit, if one of the acceleration values represents the acceleration value of the body moving toward or away from the reference light source, calculates a displacement of the body relative to the reference light source according to this acceleration value and thereby calculating the distance change according to the displacement.

9. The handheld pointing device according to claim 1, further comprising a distance measuring device configured to measure the distance between the body and the reference light source and thereby outputting a sensing result to the processing circuit.

10. The handheld pointing device according to claim 9, wherein the distance measuring device comprises a laser distance measuring device.

11. The handheld pointing device according to claim 1, further comprising a light-emitting device configured to emit a striped light on the reference light source or on a plane where the reference light source is and thereby resulting in the image captured by the image sensing module including of the image of the striped light emitting on the reference light source or on the plane where the reference light source is, and the processing circuit determines the distance of the body relative to the reference light source according to the distance between two consecutive stripes in the image captured by the image sensing module.

12. An operation method of a handheld pointing device, the handheld pointing device comprising a body and an image sensing module, the image sensing module being disposed in the body and configured to sense a reference light source and thereby capturing an image including of the reference light source, the operation method comprising:
calculating a coordinate of the image of the reference light source relative to the image captured by the image sensing module; and
correcting the coordinate according to a distance or a distance change between the body and the reference light source.

13. The operation method according to claim 12, further comprising:
determining the distance based on an image size of the reference light source.

14. The operation method according to claim 13, further comprising:
determining the reference light source whether or not having an image size matching with one of a plurality of different predetermined sizes; and
determining, if the reference light source has an image size matched with one of the predetermined sizes or the image size is within an allowable error from the predetermined size, the distance according to this one predetermined size.

15. The operation method according to claim 12, wherein the handheld pointing device further comprises an acceleration sensing device configured to obtain an acceleration value of the body moving toward or away from the reference light source, and the operation method further comprises:
calculating a displacement of the body relative to the reference light source according to the acceleration value; and
calculating the distance according to the displacement.

16. The operation method according to claim 12, wherein the handheld pointing device further comprises an acceleration sensing module configured to obtain three acceleration values of the body respectively in three dimensions of a space, and the operation method further comprises:
calculating, if one of the acceleration values represents the acceleration value of the body moving toward or away from the reference light source, a displacement of the body relative to the reference light source according to this acceleration value; and
calculating the distance according to the displacement.

17. The operation method according to claim 12, wherein the handheld pointing device further comprises a distance measuring device, and the operation method further comprises:
measuring, by the distance measuring device, the distance between the body and the reference light source.

18. The operation method according to claim 12, wherein the handheld pointing device further comprises a light-emitting device configured to emit a striped light on the reference light source or on a plane where the reference light source is and thereby resulting in the image captured by the image sensing module including of the image of the striped light emitting on the reference light source or on the plane where the reference light source is, and the operation method further comprises:
determining the distance of the body relative to the reference light source according to the distance between two consecutive stripes in the image captured by the image sensing module.

19. A handheld pointing device, comprising:
an image sensing module configured to sense at least one reference light source and thereby capturing an image including of the reference light source(s);
a lookup table recording a relationship between an imaging characteristic of the reference light source(s) and a group of coordinate adjustment parameters; and
a processing circuit electrically connected to the image sensing module and configured to obtain the image including of the reference light source(s) and correct a coordinate based on the relationship between the imaging characteristic of the reference light source(s) and the group of coordinate adjustment parameters in the lookup table.

20. The handheld pointing device according to claim 19, wherein the imaging characteristic is an imaging size of the reference light source.

21. The handheld pointing device according to claim 19, wherein the image sensing module is further configured to sense two reference light sources and thereby capturing an image including of the two reference light sources, wherein the distance change is associated with an imagining distance of the two reference light sources in the captured image.
